(19) United States
(12) Patent Application Publication
(10) Pub. No.: US 2018/0300160 A1
(43) Pub. Date: Oct. 18, 2018

(54) Host and Component Relationship between Applications

(71) Applicant: Microsoft Technology Licensing, LLC, Redmond, WA (US)

(72) Inventors: Elliot Hajime Omiya, Kirkland, WA (US); Adam D. Braden, Woodinville, WA (US); Harley Michael Rosnow, Kirkland, WA (US); Sergey Shilov, Sammamish, WA (US); Karthik Vivek Nadig, Kent, WA (US); Vinoo Cherian, Kirkland, WA (US); Cullen R. Sauls, Redmond, WA (US); Pierre-Bernard Thiffault, Seattle, WA (US); Saji Abraham, Bellevue, WA (US); Christopher Edwin Swan, Bellevue, WA (US); Venkata-Gautam Raju Kanumuru, Belleuve, WA (US); Stephen H. Wright, Bothell, WA (US); Leonardo E. Blanco, Redmond, WA (US); Francis Abraham, Redmond, WA (US)

(73) Assignee: Microsoft Technology Licensing, LLC, Redmond, WA (US)

(21) Appl. No.: 15/706,319

(22) Filed: Sep. 15, 2017

Related U.S. Application Data
(60) Provisional application No. 62/485,681, filed on Apr. 14, 2017.

(51) Int. Cl. G06F 9/44; G06F 3/0481; G06F 3/0486

(52) U.S. Cl. CPC G06F 9/4445; G06F 3/04817; G06F 3/0486; G06Q 10/06; G06F 2209/543; G06F 2209/545; G06F 8/20

(57) ABSTRACT

Implementations discussed herein provide a way for an application to host a graphical element from another application in its own window, such as in its graphical user interface (GUI). A host application that hosts a component graphical element of a component application can control the lifetime and visual appearance of the component graphical element, while the component application provides content for display within the component graphical element.

### RELATED APPLICATION

This application claims priority to U.S. Provisional Application No. 62/485,681, filed Apr. 14, 2017, entitled “Component User Interface Platform,” the disclosure of which is hereby incorporated by reference herein in its entirety.

### BACKGROUND

Modern computing systems provide platforms in which applications can execute to provide a tremendous array of different functionality. Enabling applications to interact with one another, however, presents a number of implementation challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Implementations discussed herein provide a way for an application to host a graphical element from another application in its own window, such as in its graphical user interface (GUI). A host application that hosts a component graphical element of a component application can control the lifetime and visual appearance of the component graphical element, while the component application provides content for display within the component graphical element.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 depicts an example implementation scenario for establishing a host and component relationship between applications in accordance with one or more implementations.

FIG. 3 depicts an example implementation scenario for establishing a host and component relationship between a component application and a subcomponent application in accordance with one or more implementations.

FIG. 4 depicts an example implementation scenario for disconnecting and reconnecting a component in accordance with one or more implementations.

FIG. 5 depicts an example implementation scenario for integrating accessibility with a hosted component in accordance with one or more implementations.

FIG. 6 is a flow diagram that describes steps in a method for establishing a host/component relationship between a host application and a component application in accordance with one or more implementations.

FIG. 7 is a flow diagram that describes steps in a method for enabling a graphical element of a component application to be hosted within a host GUI of a host application in accordance with one or more implementations.

FIG. 8 is a flow diagram that describes steps in a method for controlling a visual appearance of a graphical element of a component application hosted within a host GUI of a host application in accordance with one or more implementations.

FIG. 9 is a flow diagram that describes steps in a method for disconnecting and reconnecting a hosted component in accordance with one or more implementations.

FIG. 10 is a flow diagram that describes steps in a method for enabling an accessibility process to access a hosted component in accordance with one or more implementations

FIG. 11 illustrates an example system and computing device as described with reference to FIG. 1, which are configured to implement implementations of techniques described herein.

### DETAILED DESCRIPTION

Implementations discussed herein provide a way for an application to host a graphical element from another application in its own window, such as in its graphical user interface (GUI). Generally, the described techniques enable internal and external developers to implement functionality (application visuals and logic) in a reusable fashion. The application visuals and logic can be re-used by another application at any time during its lifetime, rather than re-implementing or re-packaging it.

Implementations provide process isolation between the components that make up a host and component relationship between applications, as well as provide access to an object model which allows communication between the host and the component. Further, automatic input and accessibility hook-up is provided so that a host GUI with a component graphical element looks and behaves like a cohesive unit.

Thus, the application interaction platform described herein allows applications to execute and interact as isolated from one another and from other portions of an operating system, while enabling applications to interact to enable a host-component relationship. For instance, applications inherently mistrust each other and do not have access to each other's internal components (e.g., code), but nonetheless one application is able to host another application to create an integrated and cohesive functional and visual “application within an application” experience. For instance, a running host application can host a graphical element of a running component application, enabling the component application to provide dynamic content to the graphical element while the host application can control a visual appearance of the graphical element.

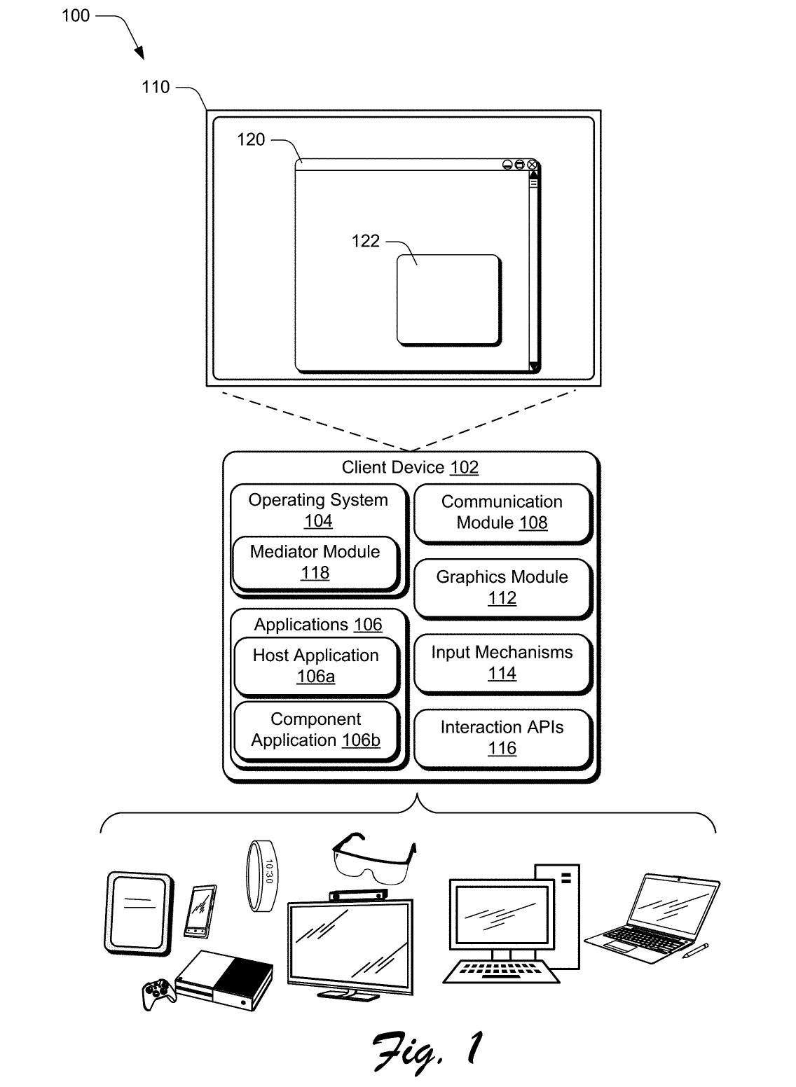

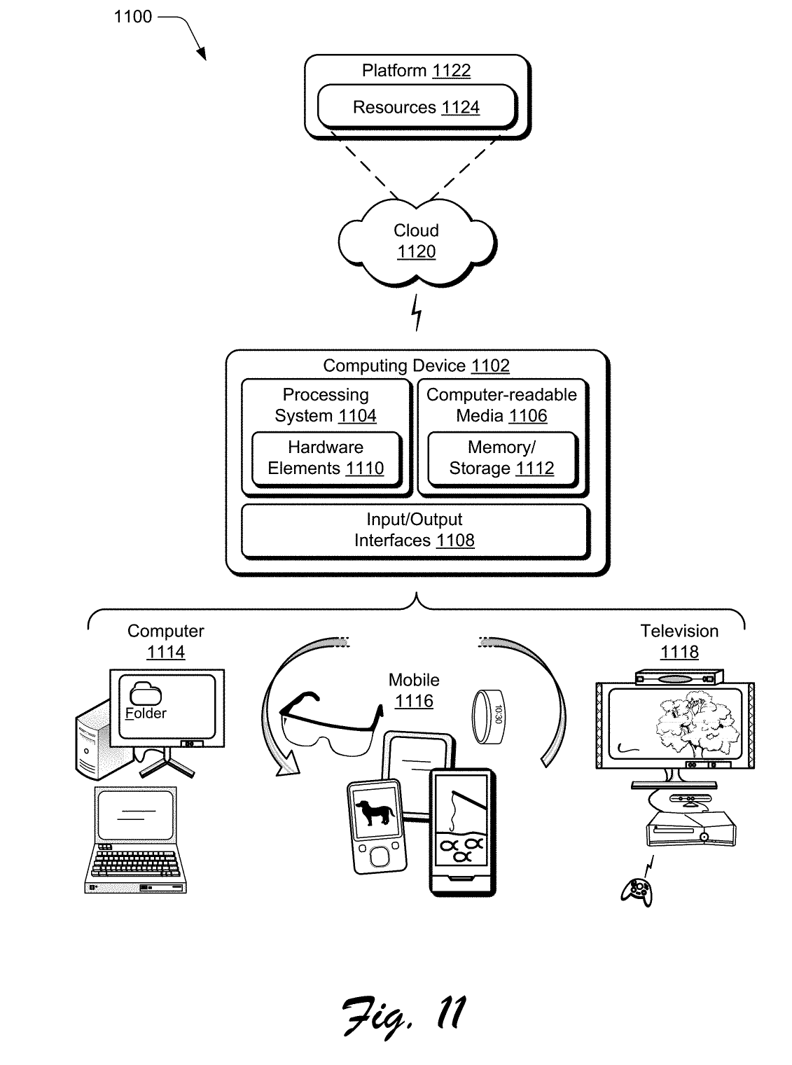

FIG. 1 is an illustration of an environment 100 in an example implementation that is operable to employ techniques for a host and component relationship between applications discussed herein. Environment 100 includes a client device 102 which can be embodied as any suitable device such as, by way of example and not limitation, a smartphone, a tablet computer, a portable computer (e.g., a laptop), a desktop computer, a wearable device, and so forth. In at least some implementations, the client device 102 represents a smart appliance, such as an Internet of Things (“IoT”) device. Thus, the client device 102 may range from a system with significant processing power, to a lightweight device with minimal processing power. One of a variety of different examples of the client device 102 is shown and described below in FIG. 11.

The client device 102 includes a variety of different functionalities that enable various activities and tasks to be performed. For instance, the client device 102 includes an operating system 104, applications 106, and a communication module 108. Generally, the operating system 104 is representative of functionality for abstracting various system components of the client device 102, such as hardware, kernel-level modules and services, and so forth. The operating system 104, for instance, can abstract various components (e.g., hardware, software, and firmware) of the client device 102 to the applications 106 to enable interaction between the components and the applications 106.

The applications 106 represents functionalities for performing different tasks via the client device 102. Examples of the applications 106 include a word processing application, a spreadsheet application, a web browser, a gaming application, and so forth. The applications 106 may be installed locally on the client device 102 to be executed via a local runtime environment, and/or may represent portals to remote functionality, such as cloud-based services, web apps, and so forth. Thus, the applications 106 may take a variety of forms, such as locally-executed code, portals to remotely hosted services, and so forth.

The communication module 108 is representative of functionality for enabling the client device 102 to communicate over wired and/or wireless connections. For instance, the communication module 108 represents hardware and logic for communication via a variety of different wired and/or wireless technologies and protocols.

The client device 102 further includes a display device 110, a graphics module 112, input mechanisms 114, and interaction application programming interfaces (APIs) 116. The display device 110 generally represents functionality for visual output for the client device 102. Additionally, the display device 110 represents functionality for receiving various types of input, such as touch input, pen input, and so forth. The display device 110, for instance, represents an instance of the input mechanisms 114.

The graphics module 112 is representative of functionality for generating graphics data for output via the display device 110. The graphics module 112, for instance, includes a rendering engine that can process and output data for display on the display device 110.

The input mechanisms 114 generally represent different functionalities for receiving input to the client device 102, and include touch input devices and touchless input devices. Examples of the input mechanisms 114 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 114 may be separate or integral with the display device 110, with integral examples including gesture-sensitive displays with integrated touch-sensitive or motion-sensitive sensors.

The interaction APIs various aspects of techniques for a host and component relationship between applications discussed herein. The interaction APIs 118, for instance, enable different instances of the applications 106 to interact in various ways, such as described below.

The operating system 104 includes a mediator module 118, which is representative of functionality for enabling an instance of an application 106 to be hosted as a component of another instance of an application 106. For instance, the display device 110 displays a host GUI 120 generated by a host application 106a. Nested within the host GUI 120 is a component graphical element 122 generated by a component application 106b. The component graphical element 122 may be implemented in various ways, such as a GUI generated by the component application 106b, a content output window, an instance of content, an animation, and so forth.

According to various implementations, the host application 106a and the component application 106b represent different instances of the applications 106. In at least some implementations, the host application 106a and the component application 106b represent different respective types of applications. As further described below, techniques described herein enable a host/component relationship to be established between the host application 106a and the component application 106b such that a graphical element of the component application 106b (e.g., the component graphical element 122) can be visually presented within the host GUI 120. The host/component relationship generally enables the host application 106a to control various visual aspects of the component graphical element 122, while preventing the host application 106a from having access to the component application 106b, and vice-versa. This enables a host/component relationship while protecting security of the respective applications.

Having described an example environment in which the techniques described herein may operate, consider now a discussion of some example implementation scenarios for a host and component relationship between applications in accordance with one or more implementations. The implementation scenarios may be implemented in the environment 100 described above, the system 1100 of FIG. 11, and/or any other suitable environment.

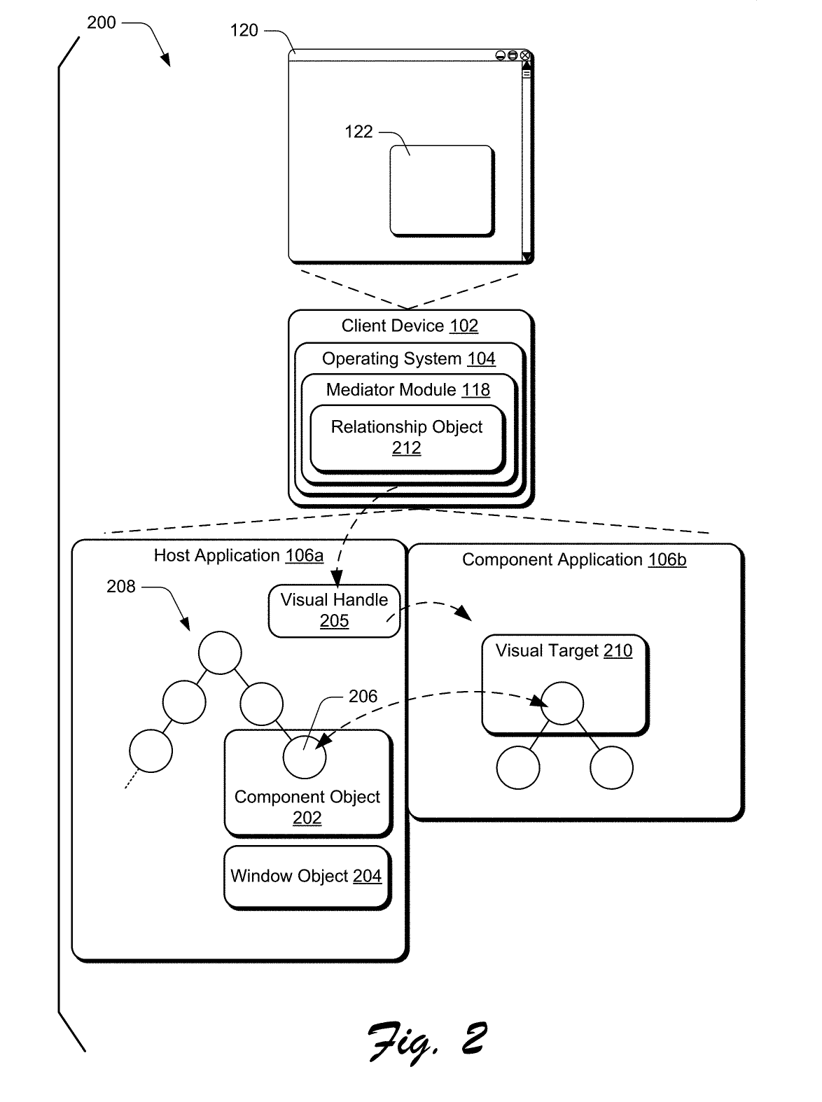

FIG. 2 depicts an example implementation scenario 200 for establishing a host and component relationship between applications in accordance with one or more implementations. The scenario 200 includes the host application 106a and the component application 106b. The host application 106a and the component application 106b, for instance, represent different respective instances of the applications 106. The scenario 200 further includes the host GUI 120 that is generated by the host application 106a, and the component graphical element 122 that is generated by the component application 106b. As shown, the component graphical element 122 is visually nested within the host GUI 120. That is, the component graphical element 122 is hosted by the host GUI 120. While the component graphical element 122 is depicted here as being fully visually nested within the host GUI 120, in at least some implementations a component graphical element may partially extend outside of a host GUI.

As part of enabling the component graphical element 122 to be embedded in the host GUI 120, the component application 106b is connected to the host application 106a. Generally, a launch and connect order between the host application 106a and the component application 106b may vary. For instance, the host application 106a may first be launched, after which the component application 106b is launched and connected to the host application 106a. In another implementation, the component application 106b is launched in an unconnected state, i.e., unconnected to a host application. The host application 106a is then launched, and the component application 106b is connected to the host application 106a. Thus, in at least some implementations, a component application may be launched and later connected to a host application.

To enable the component application 106b to be connected to the host application 106a, the mediator module 118 of the operating system 104 generates a component object 202 and a window object 204 and provides these objects to the host application 106a. Generally, the component object 202 represents an object, living in an address space of the host application 106a, that represents the component application 106b in terms of lifetime and certain events that affect the relationship between the host application 106a and the component application 106b. The component object 202 generally enables the host application 106a to control lifetime of the component graphical element 122, participate in output integration, and receive lifetime events pertaining to a state of the component application 106b, e.g., a notification that the component application 106b has crashed and thus a lifetime of the component application 106b has ended unexpectedly.

The window object 204 generally represents an abstraction over the component graphical element 122 which enables the host application 106a to communicate with the component application 106b. For instance, the window object 204 enables the host application 106a to indicate to the component application 106b a visibility state, size, placement, and so forth for the host GUI 120. The window object 204 also enables the host application 106a to receive events from the component application 106b indicating a state of the application and/or the component graphical element 122.

Further to the host/component relationship, the host application 106a retrieves a shared visual handle (“visual handle”) 205 from the operating system QQ and uses the visual handle 205 to create a shared visual 206. The shared visual 206 is appended to a visual tree 208 of the host GUI 120. Generally, the shared visual 206 represents the component graphical element 122 and is generated by the component application 106b. The host application 106a passes the visual handle 205 to the component application 106b, which uses the visual handle 205 to generate a visual target 210. The visual target 210 is a representation of the shared visual 206 that is used by the component application 106b to manage and perform various operations on the shared visual 206. For instance, visual aspects (e.g., content) to be applied to the component graphical element 122 are generated by the component application 106b by operating on the visual target 210, and the visual aspects are then propagated to the shared visual 206 to be applied for displaying the component graphical element 122. This way of generating the shared visual 206 and the visual target 210 is presented for purpose of example only, and it is to be appreciated that these data objects may be generated in a variety of different ways in accordance with the claimed implementations.

According to various implementations, interaction between the window object 204 and the component application 106b enables the host application 106a to manage various aspects of the component graphical element 122, such as to control lifetime of the component graphical element 122, participate in output integration for the component graphical element 122, and receive various application state events from the component application 106b that affect the component graphical element 122. The shared visual 206, for instance, can be controlled by the host application 106a in the same way that other visuals of the visual tree 208 are controllable by the host application 106a. This enables the host application 106a to perform different visual operations on the component graphical element 122, such as clipping, transformations, visibility control (e.g., visible or not visible), positioning within the host GUI 120, and so forth. Further, the host application 106a can temporarily remove the shared visual 206 from the visual tree 208, which causes the component graphical element 122 to be removed from display as part of the host GUI 120. The host application 106a can then reinsert the shared visual 206 into the visual tree 208, which would cause the component graphical element 122 to be redisplayed within the host GUI 120. In at least one implementation, the host application 106a can remove and reinsert the shared visual 206 without affecting a run state of the component application 106b, e.g., while the component application 106b remains in an active, running state.

Further to the scenario 200, the mediator module 118 maintains a relationship object 212, which is representative of functionality for tracking various interaction parameters for interaction between the host application 106a and the component application 106b. For instance, when a host/component relationship is established between the host application 106a and the component application 106b, this relationship is recorded as the relationship object 212. In at least one implementation, when an operation involves traversing a boundary (e.g., a functional and/or security boundary) between the host application 106a and the component application 106b, the relationship object 212 can be queried to identify whether a relationship exists between the host application 106a and the component application 106b such that the operation is permitted.

Thus, an interactivity relationship is established between the host application 106a and the component application 106b whereby the host application 106a controls whether and how the component graphical element 122 is displayed within the host GUI 120. In turn, the component application 106b controls what content is displayed within the component graphical element 122, and how the content is displayed. Thus, the graphical element 122 is displayed within the host GUI 120 while both the host application 106a and the component application 106b are executing in a running state, enabling dynamic changes to both the graphical element 122 and the host GUI 120 while the host application 106a and the component application 106b maintain a connected relationship. Generally, the described interactivity architecture provides a security barrier between the host application 106a and the component application 106b. For instance, input and output can be routed between the component application 106b and the component graphical element 122 to enable changes to the component graphical element 122 to be effected, while preventing the host application 106a and the component application 106b from being mutually accessible to one another. Input to the component graphical element 122, for example, is routed to the component application 106b to enable the component application 106b to process the input in various ways, such as to effect a visual change to the component graphical element 122. Alternatively or additionally, such input may be routed to the host application 106a before and/or after it's routed to the component application 106b. Further, visual output generated by the component application 106b is applied to the shared visual 206 to cause the visual output to be output in the component graphical element 122.

Thus, while the host application 106a can control display of the component graphical element 122 within the host GUI 120, the host application 106a is prevented from accessing the content of the component graphical element 122 along with other assets (e.g., program code) of the component application 106b. Thus, the host application 106a maintains the shared visual 206 for displaying the component graphical element 122, but the component application 106b is prevented from accessing assets of the actual host application 106a itself. Accordingly, a shared visual relationship is established that enables a clearly defined visual to be jointly shared between two applications, while preventing application code and other application assets from being accessible outside the defined shared visual relationship.

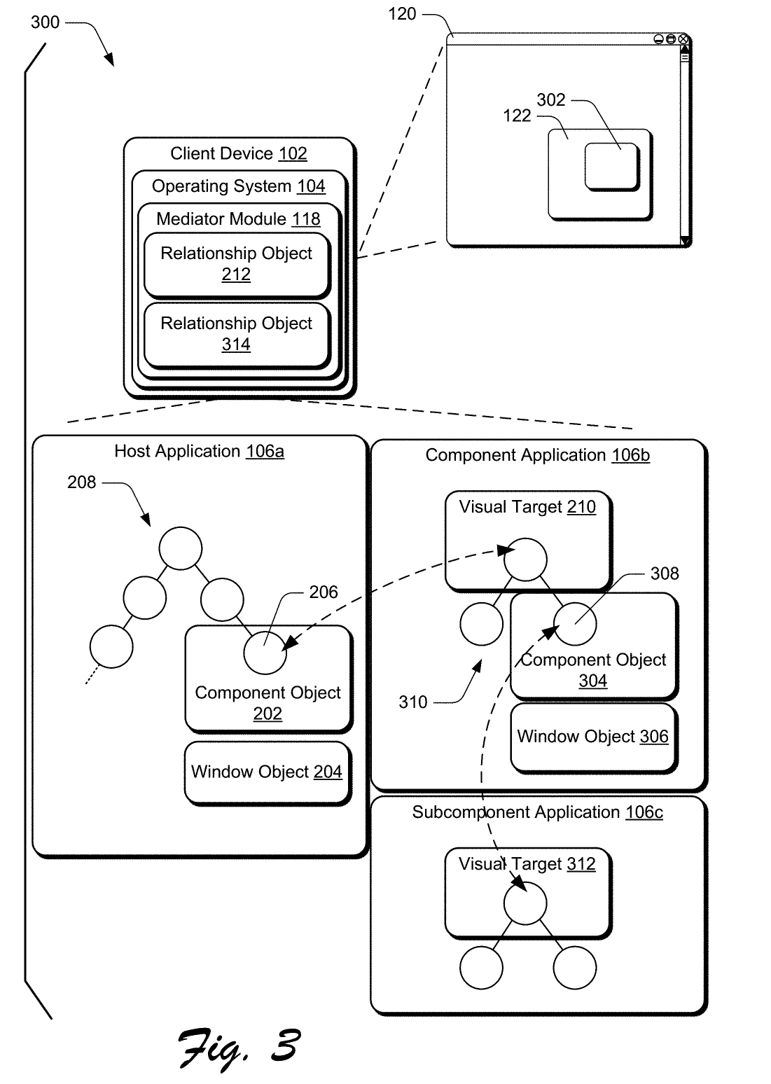

FIG. 3 depicts an example implementation scenario 300 for establishing a host and component relationship between a component application and a subcomponent application in accordance with one or more implementations. The scenario 300 includes the host application 106a and the component application 106b, introduced above. Further, a host-component relationship has been established to enable the component graphical element 122 to be hosted within the host GUI 120, such as described above.

In the scenario 300, a further host-component relationship is established between the component application 106b and a subcomponent application 106c. This enables a subcomponent graphical element 302 generated by the subcomponent application 106c to be hosted within the component graphical element 122. Thus, the component application 106b serves as a host application to a further component application represented by the subcomponent application 106c. This enables a nested chain of host/component relationships to be established and managed whereby the host application 106a hosts the component graphical element 122 within the host GUI 120, while the component application 106b hosts the subcomponent graphical element 302 within the component graphical element 122.

To enable this further host/component relationship to be established, the mediator module 118 generates a component object 304 and a window object 306 and provides these objects to the component application 106b. Generally, the component object 304 represents an object, living in an address space of the component application 106b, that represents the subcomponent application 106c in terms of lifetime and certain events that affect the relationship between the component application 106b and the subcomponent application 106c. The component object 304, for instance, allows the component application 106b to control lifetime of the subcomponent graphical element 302, participate in output integration, and receive lifetime events pertaining to a state of the subcomponent application 106c.

The window object 306 generally represents an abstraction over the subcomponent graphical element 302 which enables the component application 106b to communicate with the subcomponent application 106c. For instance, the window object 306 enables the component application 106b to indicate to the subcomponent application 106c a visibility state, size, placement, and so forth for the subcomponent graphical element 302. The window object 306 also enables the component application 106b to receive events from the subcomponent application 106c indicating a state of the application and/or the subcomponent graphical element 302.

Further to the host/component relationship between the component application 106b and the subcomponent application 106c, the window object 306 requests a visual component from the subcomponent application 106c, and thus a shared visual 308 is obtained by the component application 106b. In at least one implementation, the shared visual 308 is obtained using a visual handle, such as described in the scenario 200. The shared visual 308 is then appended to a visual tree 310 of the component graphical element 122.

The subcomponent application 106c maintains a visual target 312, which is a representation of the shared visual 308 that is used by the subcomponent application 106c to manage and perform various operations on the shared visual 308. For instance, visual aspects to be applied to the subcomponent graphical element 302 are generated by the subcomponent application 106c by operating on the visual target 312, and the visual aspects are then propagated to the shared visual 308 to be applied for displaying the subcomponent graphical element 302.

According to various implementations, interaction between the window object 306 and the subcomponent application 106c enables the component application 106b to manage various aspects of the subcomponent graphical element 302, such as to control lifetime of the subcomponent graphical element 302, participate in output integration for the subcomponent graphical element 302, and receive various application state events from the subcomponent application 106c that affect the subcomponent graphical element 302. The shared visual 308, for instance, can be controlled by the component application 106b in the same way that other visuals of the visual tree 310 are controllable by the component application 106b. This enables the component application 106b to perform different visual operations on the subcomponent graphical element 302, such as clipping, transformations, visibility control (e.g., visible or not visible), positioning within the component GUI 122, and so forth.

Further to the scenario 300, the mediator module 118 generates a relationship object 314 which is representative of functionality for tracking various interaction parameters for the interactions between the component application 106b and the subcomponent application 106c. In at least one implementation, when an operation involves traversing a boundary (e.g., a functional and/or security boundary) between the component application 106b and the subcomponent application 106c, the relationship object 314 can be queried to identify whether a relationship exists between the component application 106b and the subcomponent application 106c such that the operation is permitted.

Generally, the host/component restraints and parameters discussed above with respect to the host application 106a and the component application 106b apply to the host/component relationship between the component application 106b and the subcomponent application 106c. For instance, the component application 106b controls how and whether the subcomponent graphical element 302 is displayed within the component GUI 122, but cannot access content that is displayed within the subcomponent graphical element 302. The subcomponent application 106c, for instance, generates the subcomponent graphical element 302 and populates content to the subcomponent graphical element 302, and the component application 106b controls how the subcomponent graphical element 302 is displayed within the component GUI 122. The component application 106b can apply various visual operations to the subcomponent graphical element 302, such as clipping, transformations, visibility control (e.g., visible or not visible), positioning within the component graphical element 122, temporary removal from and reinsertion into the component graphical element 122, and so forth.

According to various implementations, visual operations performed by the host application 106a to the component graphical element 122 can be propagated to the subcomponent graphical element 302. For instance, if the host application 106a removes the component graphical element 122 from display in the host GUI 120, the subcomponent graphical element 302 is also removed from display. In at least some implementations, when the host application 106a performs a visual transformation to the component graphical element 122, the transformation is propagated to the component application 106b which performs a corresponding transformation to the subcomponent graphical element 302. For instance, consider that the host application 106a resizes the component graphical element 122 within the host GUI 120. The component application 106b may perform a corresponding resizing of the subcomponent graphical element 302 within the component graphical element 122. In one particular implementation, however, the subcomponent graphical element 302 may be subject to a particular resizing constraint such that when the component graphical element 122 is resized, a size of the subcomponent graphical element 302 remains static within the component graphical element 122, and/or is not permitted to be resized below a certain size limit.

Generally, the architecture described in the scenario 300 enables input to the subcomponent graphical element 302 to be passed to the subcomponent application 106c. For instance, the mediator module 118 knows based on the relationship object 314 that the subcomponent graphical element 302 belongs to the subcomponent application 106c. Accordingly, when input is received to the subcomponent graphical element 302, the mediator module 118 causes the input to be routed to the subcomponent application 106c. Further, output from the subcomponent application 106c is routed from the visual target 312 to the shared visual 308 for display as part of the subcomponent graphical element 302.

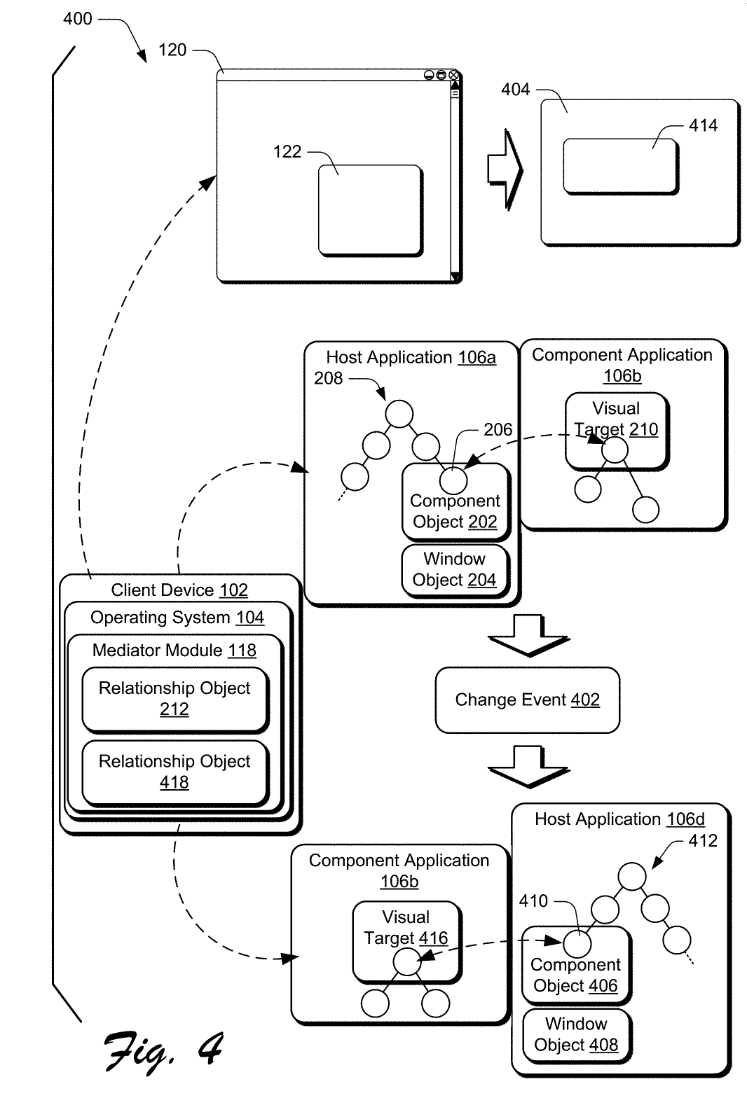

FIG. 4 depicts an example scenario 400 for disconnecting and reconnecting a component in accordance with one or more implementations. The scenario 400, for instance, represents a continuation of and/or variation on the scenario 200 discussed above.

In the scenario 400, a host/component relationship is established between the host application 106a and the component application 106b, such as described above. Thus, the component graphical element 122 is nested within the host GUI 120. A change event 402 occurs, however, that initiates a process of disconnecting the component application 106b from the host application 106a, and reconnecting the component application 106b to a different host application 106d. Generally, the change event 402 can occur in various ways. For instance, a user can request that the component graphical element 122 be moved from the host GUI 120 to a host GUI 404 for the host application 106d. The user, for example, can perform a drag and drop gesture or other input action to move the component graphical element 122 from the host GUI 120 to the host GUI 404. In another example, the change event 402 can be initiated by an application-initiated process, such as a request by the host application 106a and/or the host application 106d. As yet another example, the change event 402 can be initiated by a system process, such as by the operating system 104.

In response to the change event 402, the component application 106b is disconnected from the host application 106a. The mediator module 118, for instance, deactivates the component object 202 and the window object 204 to cause the host/component relationship between the host application 106a and the component application 106b to be disengaged. Thus, the component graphical element 122 is visually removed from the host GUI 120. In at least some implementations, the mediator module 118 updates the relationship object 212 to indicate that the component application 106b is disconnected from the host application 106a. Alternatively or additionally, the mediator module 118 deletes the relationship object 212.

A connect process is then performed to cause a graphical element for the component application 106b to be connected to the host application 106d. Generally, a disconnect process and a connect process represent separate and distinct processes that can be performed separately to enable a variety of different scenarios. For instance, in at least one implementation the host application 106d is launched before the component application 106b is disconnected from host application 106a. Alternatively, the component application 106b is disconnected from the host application 106a before the host application 106d is launched. After the component application 106b is disconnected from the host application 106a, the host application 106d is launched and the component application 106b is connected to the host application 106d.

Further to connecting the component application 106b to the host application 106d, the mediator module 118 generates a component object 406 and a window object 408, and binds these objects to the host application 106d. Further, a shared visual 410 is communicated from the component application 106b to the host application 106d, and the shared visual 410 is appended to a visual tree 412 of the host application 106d. Generally, this causes a component graphical element 414 to be visually nested within the host GUI 404. The component graphical element 414 is generated by the component application 106b. The component graphical element 414 may be a visual duplicate of the component graphical element 122, or may be visually different than the component graphical element 122. The host application 106d, for instance, may apply a different visual configuration to the component graphical element 414 than the host application 106a applied to the component graphical element 122.

Further to the scenario 400, the component application 106b maintains a visual target 416, which is a representation of the shared visual 410 that is used by the component application 106b to manage and perform various operations on the shared visual 410. For instance, visual aspects to be applied to the component graphical element 414 are generated by the component application 106b by operating on the visual target 416, and the visual aspects are then propagated to the shared visual 410 to be applied for displaying the component graphical element 414.

To enable input to the component graphical element 414 to be properly routed to the component application 106b, the mediator module 118 generates a relationship object 418, which is representative of functionality for tracking various interaction parameters for interaction between the host application 106d and the component application 106b. Different attributes of relationship objects are described above.

In at least some implementations, the various interactions and functionalities discussed above that pertain to the host/component relationship between the host application 106a and the component application 106b, also apply to the host/component relationship between the host application 106d and the component application 106b. For instance, the host application 106d can perform visual operations on the component graphical element 414 to visually configure the component graphical element 414, and visual output from the component application 106b can be output within the component graphical element 414. Further, input to the component graphical element 414 is routed to the component application 106b.

Generally, the component application 106b can be disconnected from the host application 106a and reconnected to the host application 106d in different ways. For instance, the disconnect/reconnect process can occur while the component application 106b is running, that is, without stopping execution of the component application 106b while the component application 106b is disconnected from the host application 106a and reconnected to the host application 106d. Alternatively, the component application 106b can be paused and/or closed during the disconnect/reconnect process, and then restarted when the component application 106b is reconnected to the host application 106d.

While the scenario 400 is described with reference to disconnecting the component application 106b from the host application 106a and reconnecting to the different host application 106d, it is to be appreciated that a variation on the scenario can be implemented to disconnect the component application 106b from the host application 106a, and then reconnect the component application 106b to the host application 106a.

Accordingly, techniques described herein enable a component application to be disconnected from one host, and reconnected to another host. Further, in an implementation where a component application acts as a host for a subcomponent application (e.g., as described in the scenario 300), the subcomponent application may remain hosted by the component application across a disconnect/reconnect process.

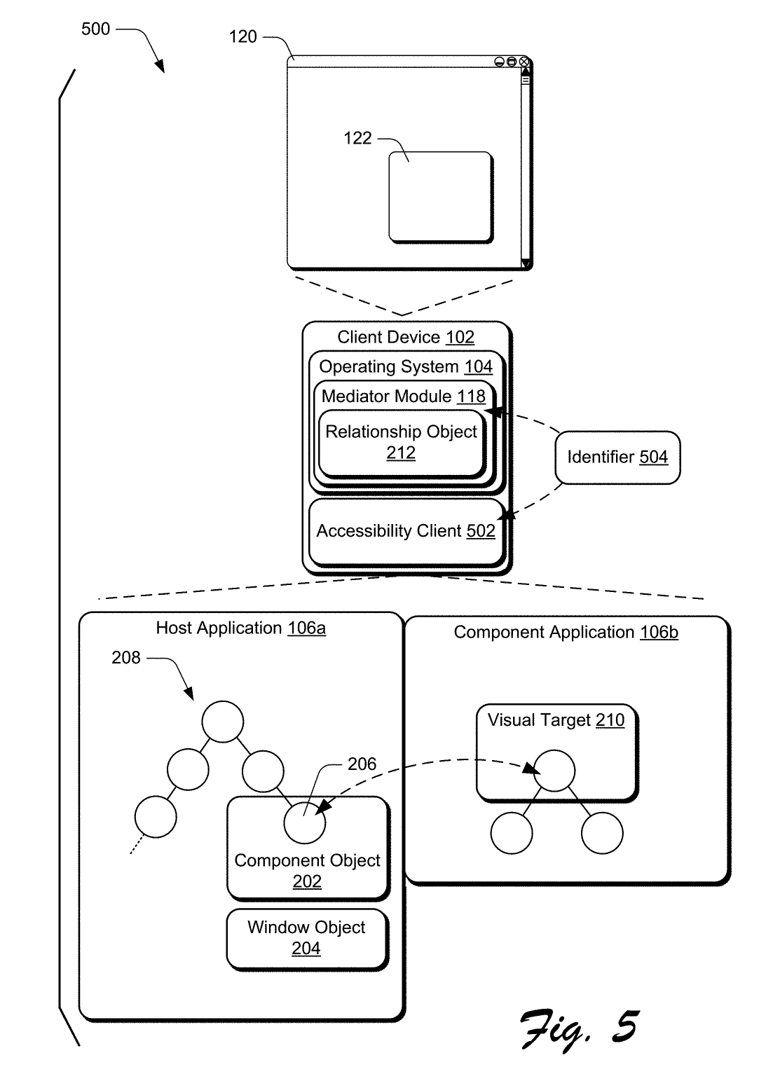

FIG. 5 depicts an example scenario 500 for integrating accessibility with a hosted component in accordance with one or more implementations. The scenario 500 includes the host application 106a and the component application 106b with a host/component relationship, such as described above. Also shown is an accessibility client 502, which represents an application and/or process that provides content accessibility for individuals with a disability, such as visual impairment, hearing impairment, communication impairment, and so forth. In one example, the accessibility client 502 includes a screen reader that is capable of reading and audibly outputting text and other information, such as for someone with a visual impairment.

In the context of accessibility, the host application 106a and the component application 106b are considered accessibility providers that provide content that can be processed and output by the accessibility client 502. Accordingly, techniques described herein enable the accessibility client 502 to properly navigate the host/component paradigm such that respective content from the host GUI 120 and the component graphical element 122 can be accurately processed and output by the accessibility client 502.

As described above, the relationship object 212 indicates the host/component relationship between the host application 106a and the component application 106b. Thus, consider a scenario where the accessibility client 502 is processing content included in the host GUI 120 for output, such as text content for audible output. The accessibility client 502 traverses the visual tree 208 to obtain the content from the host GUI 120 and encounters the shared visual 206. Accordingly, the accessibility client 502 queries the mediator module 118 for information about the shared visual 206. The mediator module 118, for instance, serves as an accessibility manager that moderates accessibility interactions between the accessibility client 502, the host application 106a, and the component application 106b.

In response to the query, the mediator module 118 returns an identifier 504 from the relationship object 212 to the accessibility client 502 that identifies the component application 106b. The accessibility client 502 uses the identifier 504 to interact with the component application 106b and access content from the component graphical element 122. The accessibility client 502, for instance, is able to access content that is generated by the component application 106b and displayed within the component graphical element 122, such as text content. In an example where the accessibility client 502 is a screen reader, the accessibility client 502 can read text content displayed within the component graphical element 122 and audibly output a spoken version of the text content. This is not intended to be limiting, however, and implementations described herein can enable a wide variety of different accessibility processes to navigate a host/component visual and functional relationship.

Thus, techniques described herein enable accessibility-related processes to accurately consume content from both a host and a component, and without requiring either the host or the component to have access to content outside of their own respective processes. For instance, in the scenario above, the accessibility client 502 is able to access and process host-related content from both the host GUI 120 outside of the component graphical element 122, and component-related content from the component graphical element 122. Further, the accessibility client 502 can access this different content without enabling the host application 106a to have access to the component-related content, or the component application 106b to have access to the host-related content. Thus, in addition to providing an efficient way of obtaining content across the host/component relationship, security of the respective host and component processes is preserved by preventing the processes from being mutually accessible.

Having described some example implementation scenarios, consider now some example procedures for host and component relationship between applications in accordance with one or more implementations. Generally, the procedures may be implemented in the environment 100 described above, the system 1100 of FIG. 11, and/or any other suitable environment. The procedures, for example, describe example ways for implementing various aspects of the scenarios described above. In at least some implementations, steps described for the various procedures are performed automatically and independent of user interaction.

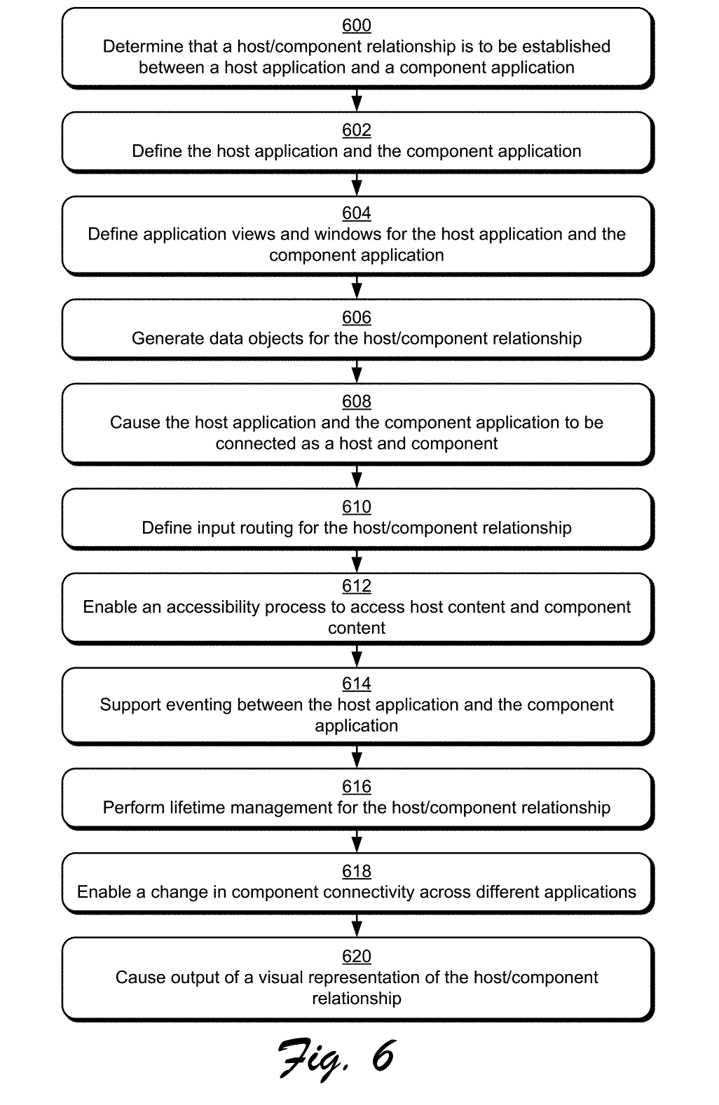

FIG. 6 is a flow diagram that describes steps in a method in accordance with one or more implementations. The method describes an example way for establishing a host/component relationship between a host application and a component application.

Step 600 determines that a host/component relationship is to be established between a host application and a component application. The mediator module 118, for instance, receives a request from a host application to enable the host application to host a graphical element from a component application.

Step 602 defines the host application and the component application. For example, the mediator module 118 generates a relationship object that identifies that host application and the component application. The relationship object, for instance, includes an identifier for each application and an indication of a role for each respective application, e.g., which application is a host, and which application is a component.

Step 604 defines application views and windows for the host application and the component application. Generally, the application views represent different view state relationships between a host GUI for the host application, and a graphical element of the component application that is hosted within the host GUI. Examples of different view states include:

Visible—When the host GUI is visible, a component graphical element is visible.

Obscured—When the host GUI is not visible (e.g., is obscured by another visual object), a component graphical element is not visible.

Inactive—When the host application is suspended, the component application is suspended. Generally, a suspended application is an application whose execution is temporarily paused, such as when a user's focus switches to a different application.

Resumed—When the host application is resumed (e.g., from an inactive state), the component application is resumed.

Closed—When the host GUI is closed, the component graphical element is closed. In an implementation where a component application has views (e.g., graphical elements) being hosted by multiple host applications contemporaneously and one of the host applications closes, a component view for the closed host application will also close while a different component view for a different host application that remains open will remain open.

Termination—When a host process that generates a host GUI is terminated, a component process that generates a component graphical element may be terminated. However, in an implementation where a component application is hosted by multiple host applications and one of the host applications is terminated, the component application will remain active and hosted by the remaining active host application. Generally, a termination state is representative of a process state, whereas a closed state (discussed above) is view-oriented.

According to various implementations, defining a window for a host/component relationship includes identifying a host GUI into which a component graphical element is to be nested.

Step 606 generates data objects for the host/component relationship. The mediator module 118, for instance, generates a component object and a window object to be used by the host application for hosting the component application, and binds these objects to the host application. Different attributes of a component object and a window object are discussed above.

Step 608 causes the host application and the component application to be connected as a host and component. For example, the mediator module 118 causes the component application to be launched, and a shared visual from the component application to be provided to the host application. Generally, this causes a graphical element represented by the shared visual to be embedded in a host GUI of the host application.

Step 610 defines input routing for the host/component relationship. The mediator module 118, for instance, defines an input path that specifies that input to the component graphical element is to be routed to the component application, and not to the host application. In at least some implementations, this prevents the input from being exposed to and accessible by the host application.

Step 612 enables an accessibility process to access host content and component content. As detailed elsewhere herein, the mediator module 118 can enable an accessibility-related process to access both content of a host GUI, and content of a component graphical element hosted within the host GUI.

Step 614 supports eventing between the host application and the component application. Generally, this enables the respective applications to receive events pertaining to the applications, and to perform an appropriate action. Examples of different events include:

Process Exited—This event informs a host application that a component application has died unexpectedly, e.g., it has crashed due to a bug or other error in the component application.

Element Ready—This event informs a host application that a component application has rendered at least its first frame of composition data, i.e., that at least a portion of a component graphical element is ready to be presented with a host GUI.

Window Closed—This event informs a host application that a graphical element (e.g., a component GUI) into which a component application is rendering content has closed, but an application process for the component application has not exited.

Modal Dialogue—This event informs a host application that a component application has attempted to show a graphical element (e.g., a dialog) which is modal.

Step 616 performs lifetime management for the host/component relationship. The mediator module 118, for instance, enables lifetime events to be propagated between the host application and the component application. Generally, lifetime events pertain to process states, which can be distinguished from visual states. Examples of different process states include application launch, application suspended, application closed, and so forth. In at least some implementation, this involves informing a component application of a lifetime event pertaining to a host application. For instance, if a host application is suspended or closed, a component application is to be suspended or closed.

Step 618 enables a change in component connectivity across different applications. As described above, for instance, the mediator module 118 can enable a component application that is connected to a first host application to be disconnected from the first host application, and reconnected to a different host application.

Step 620 causes output of a visual representation of the host/component relationship. The operating system 104, for instance, causes the graphics module 112 to output a host GUI and a component graphical element within the host GUI on the display device 110. Generally, the different events and processes described above can occur dynamically to configure and reconfigure a host GUI and/or a component graphical element, and thus cause changes to their visual appearance and/or visibility status.

The aforementioned procedure describes a general way of implementing and supporting various aspects of a host/component architecture. The procedures described below describe particular implementations of a host/component paradigm, and can be combined with various features of the aforementioned procedure to provide a rich set of host/component interactions and functionality.

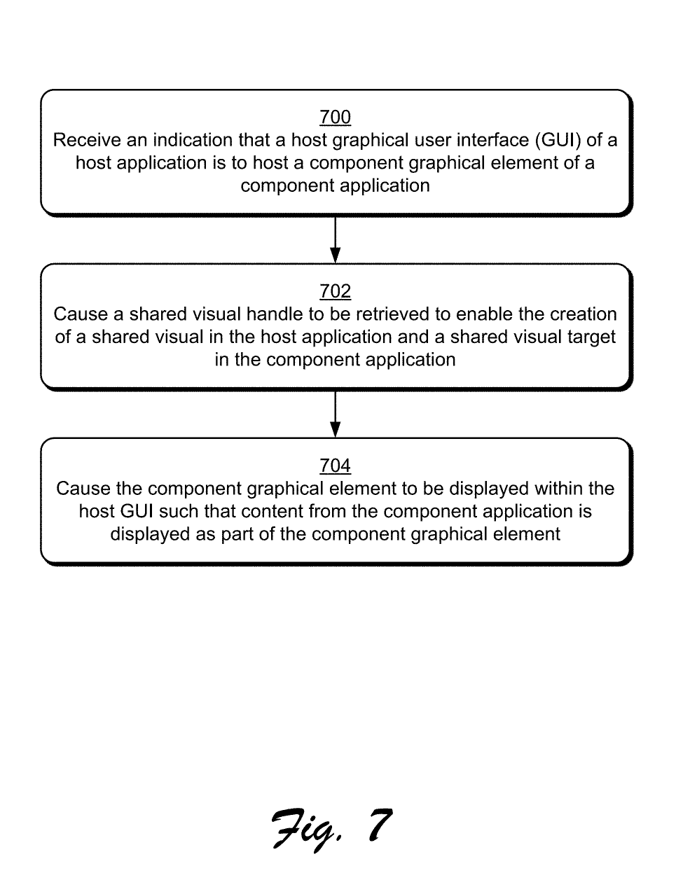

FIG. 7 is a flow diagram that describes steps in a method in accordance with one or more implementations. The method describes an example way for enabling a graphical element of a component application to be hosted within a host GUI of a host application.

Step 700 receives an indication that a host graphical user interface (GUI) of a host application is to host a component graphical element of a component application. The mediator module 118, for instance, receives an indication that a host application is requesting that a graphical element (e.g., a component GUI) of a component application be nested within a host GUI. Generally, this indication can result from various actions, such as a request by a user and/or the host application for a particular type of content/functionality provided by the component application.

Step 702 causes a shared visual handle to be retrieved to enable the creation of a shared visual object in the host application and a shared visual target in the component application. In at least one implementation, the shared visual object is generated by the host application and represents the component graphical element. The shared visual object, for instance, is a data object that includes graphics data representing different visual aspects of the component graphical element, such as size, shape, color, content, and so forth. Further, the shared visual object is operable to receive visual output from the component application for display as part of the component graphical element, and enables the host application to control one or more visual aspects of the component graphical element. As described above, for instance, the host application can be perform various visual and positional transformations on the component graphical element by operating on the shared visual object.

Step 704 causes the component graphical element to be displayed within the host GUI such that content from the component application is displayed as part of the component graphical element. The shared visual object, for instance, is appended to a visual tree managed by the host application, which causes a corresponding component graphical element to be rendered by the graphics module 112 within the host GUI. The host application controls display and lifetime of the component graphical element, and thus the host application is protected from being accessible to the component application.

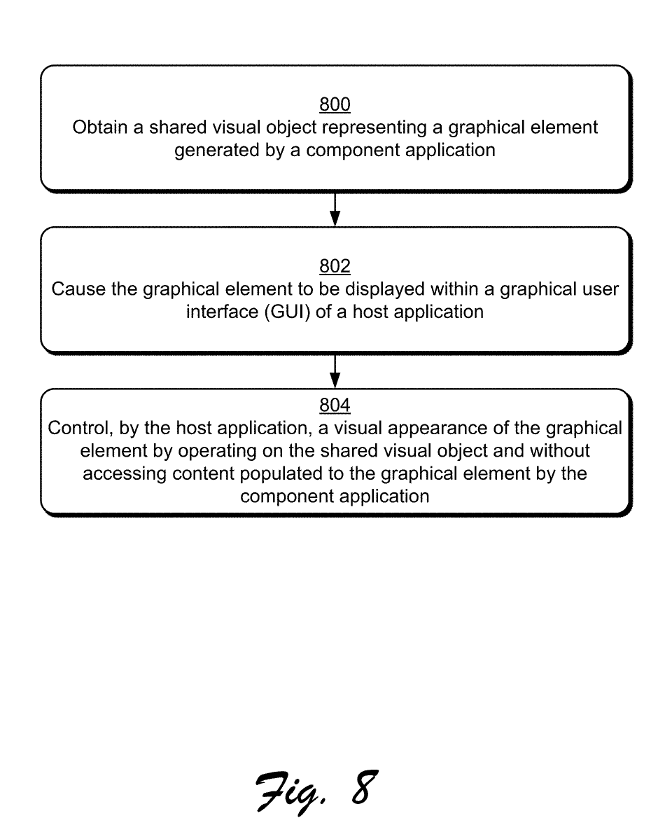

FIG. 8 is a flow diagram that describes steps in a method in accordance with one or more implementations. The method describes an example way for controlling a visual appearance of a graphical element of a component application hosted within a host GUI of a host application.

Step 800 obtains a shared visual object representing a graphical element generated by a component application. A host application, for instance, generates the shared visual object using a visual handle as part of a connection process for established a host/component relationship.

Step 802 causes the graphical element to be displayed within a graphical user interface (GUI) of a host application. For example, the host application nests the graphical element into its own GUI. As described above, the host application can append the shared visual object to its visual tree to cause the graphical element to be displayed within a host GUI.

Step 804 controls, by the host application, a visual appearance of the graphical element by operating on the shared visual object and without accessing content populated to the graphical element by the component application. As detailed above, a host application can perform various visual operations on a component graphical element, and can control a visibility state of the graphical element.

Generally, the procedures described above can be employed to establish and manage a host/component relationship between a host application and a component application, and/or between a component application and a subcomponent application.

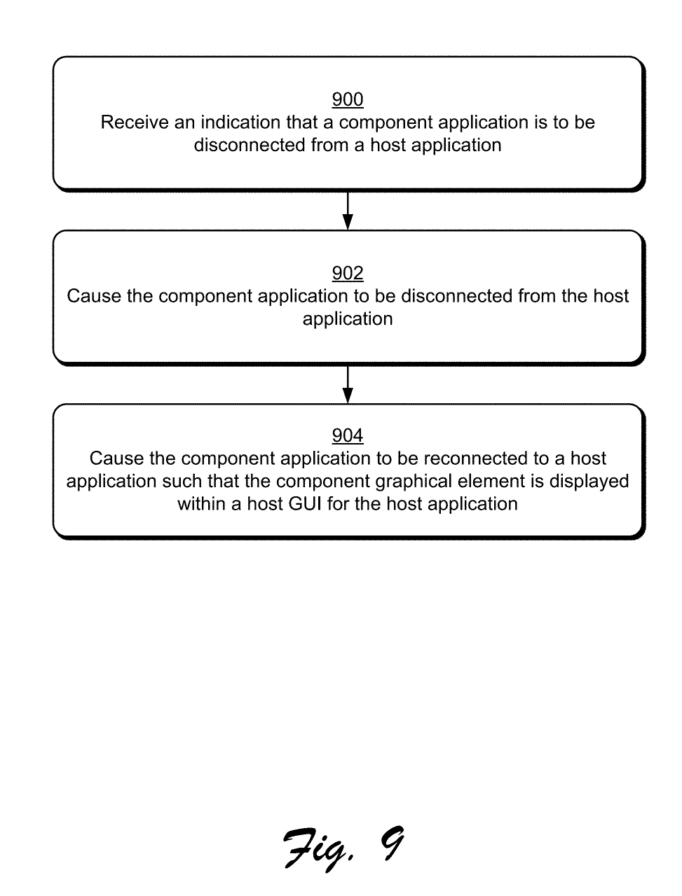

FIG. 9 is a flow diagram that describes steps in a method in accordance with one or more implementations. The method describes an example way for disconnecting and reconnecting a hosted component.

Step 900 receives an indication that a component application is to be disconnected from a host application. For instance, the mediator module 118 receives a request to disconnect the component application from a host application. In one example implementation, the mediator module 118 receives a request from the host application and/or the different host application requesting that a component graphical element for the component application be moved from a host GUI of the host application to a different host GUI of the different host application.

Step 902 causes the component application to be disconnected from the host application. In at least some implementations, this involves deactivating and/or deleting data objects used by the host application to connect to the component application, such as a shared visual object, a component object, and/or a window object.

Step 904 causes the component application to be reconnected to a host application such that the component graphical element is displayed within a host GUI for the host application. The host application may be a different host application than the host from which the component application was disconnected, or may be the same host application. The mediator module 118, for instance, generates a new component object and a new window object, and binds these to the host application. Further, the component application generates a new shared visual, and provides this to the host application. Thus, a host/component relationship is established between the component application and the host application. This enables a different host application and/or the original host application to embed a graphical element generated by the component application into its GUI.

According to various implementations, this process for disconnecting and reconnecting a component application can be performed while the component application remains in an active, running state. Alternatively, execution of the component application can be suspended during the disconnect/reconnect process.

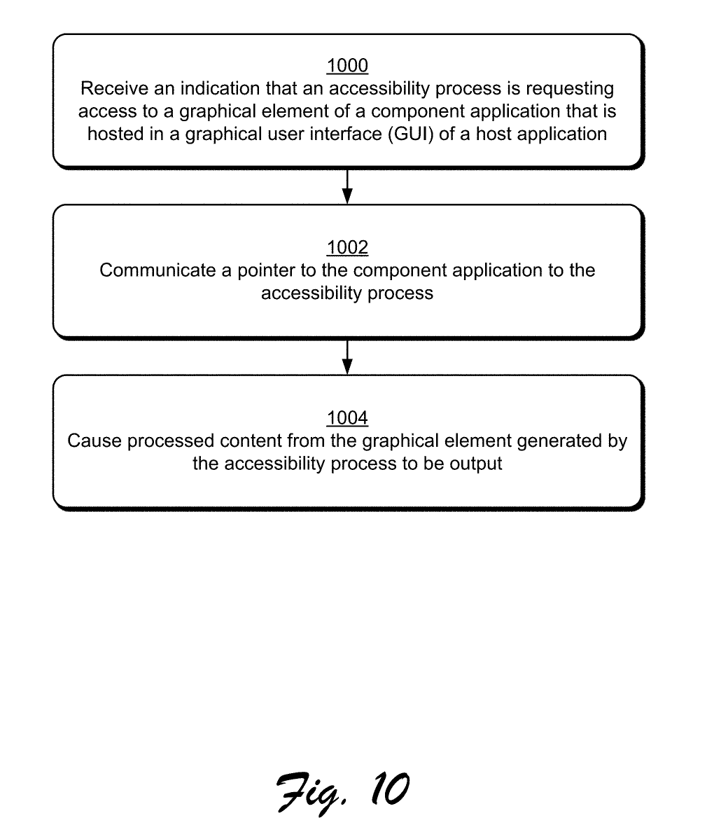

FIG. 10 is a flow diagram that describes steps in a method in accordance with one or more implementations. The method describes an example way for enabling an accessibility process to access a hosted component.

Step 1000 receives an indication that an accessibility process is requesting access to a graphical element of a component application that is hosted in a graphical user interface (GUI) of a host application. The accessibility process, for instance, is generated by an accessibility client, such as described above. In at least some implementations, the accessibility process represents a 3^{rd} party process that seeks access to host content presented in the host GUI, and component content presented as part of a component graphical element.

Step 1002 communicates a pointer to the component application to the accessibility process. The mediator module 118, for instance, communicates the pointer to the accessibility process. The pointer may be implemented in various ways, such as an identifier of the component application, a pointer to a memory address of the component application, screen coordinates for the graphical element, and so forth. In at least one implementation, the pointer is obtained from a relationship object maintained for the host/component relationship between the host application and the component application.

In one example, the operating system 104 includes an accessibility system that maintains a graph with nodes of objects that represent various GUI elements, such as a host GUI and a component GUI. A UI client like the accessibility client 502 can traverse the nodes to move between GUI elements. When the UI client encounters a node identified as a host/component boundary, it allows traversal from a host node to the top of a component accessibility node or vice versa to traverse from the top of the component accessibility node to its corresponding host node in the host application. Generally, this enables the UI client to process GUI elements across a host/component boundary.

Step 1004 causes processed content from the graphical element generated by the accessibility process to be output. Generally, the accessibility process can process content from the graphical element in various ways, such as be converting text into audio output, generating enlarged text from text content, modifying input modality for the graphical element to account for a physical disability, and so forth. Thus, the host/component architecture described herein can enable a third-party process such as an accessibility process to navigate a host/component visual relationship and access content from both a host application and a component application.

Having described some example implementation details, consider now a discussion of an example system and device in accordance with one or more implementations.

FIG. 11 illustrates an example system generally at 1100 that includes an example computing device 1102 that is representative of one or more computing systems and/or devices that may implement various techniques described herein. For example, the client device 102 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more Input/Output (I/O) Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), six degrees of freedom controllers such as used in virtual reality and augmented reality technologies, and so forth. Examples of output devices include a display device (e.g., a monitor or projector), speakers, a printer, a network card, tactile-response device, head mounted displays (e.g., for virtual reality and augmented reality applications), and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1110 and computer-readable media 1106 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules that are executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a wearable device, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the client device 102 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for enabling a graphical element of a component application to be displayed as part of a graphical user interface (GUI) of a host application, the system including: at least one processor; and one or more computer-readable storage media including instructions stored thereon that, responsive to execution by the at least one processor, cause the system to perform operations including: receiving an indication that a host graphical user interface (GUI) of a host application is to host a component graphical element of a component application; causing a shared visual handle to be retrieved to enable the creation of a shared visual in the host application and a shared visual target in the component application, the shared visual object representing the component graphical element, operable to receive visual output from the component application for display as part of the component graphical element, and enabling the host application to control one or more visual aspects of the component graphical element; and causing the component graphical element to be displayed within the host GUI such that content from the component application is displayed as part of the component graphical element while the host application is protected from being accessible to the component application.

In addition to any of the above described systems, any one or combination of: wherein the indication that the host GUI is to host the component graphical element includes one or more of a user request or a request from the host application; wherein the host application and the component application respectively represent instances of two different types of applications; wherein said causing the shared visual object to be communicated to the host application causes the shared visual object to be appended to a visual tree of the host application; wherein the operations further include: receiving an indication that the component graphical element is to host a subcomponent graphical element of a subcomponent application; causing a host/component relationship to be established between the component application and the subcomponent application; and causing the subcomponent graphical element to be displayed as part of the component graphical element while the component graphical element is displayed as part of the host GUI; wherein the operations further include causing input to the component graphical element to be routed to the component application; wherein the shared visual object enables content generated by the component application to be displayed as part of the graphical element, without enabling the host application to access the content; wherein the operations further include: receiving an indication that the component application is to be disconnected from the host application; causing the component application to be disconnected from the host application; and causing the component application to be connected to one or more of the host application or a different host application such that the component graphical element is displayed within one or more of the host GUI for the host application or a different host GUI for the different host application; wherein the operations further include enabling an accessibility process to access component content presented within the component graphical element and host content presented in the host GUI outside of the component graphical element.

A computer-implemented method for enabling a host application to control a visual appearance of a graphical element of a component application, the method including: receiving a shared visual object representing a graphical element generated by the component application; causing the graphical element to be displayed within a host graphical user interface (GUI) of a host application; and controlling, by the host application, a visual appearance of the graphical element within the host GUI by operating on the shared visual object and without accessing content populated to the graphical element by the component application.

In addition to any of the above described methods, any one or combination of: wherein said receiving the shared visual object is based on a request from the host application for the graphical element; wherein said causing the graphical element to be displayed with the GUI of the host application includes appending the shared visual object to a visual tree of the host application; wherein said controlling the visual appearance of the graphical element includes changing, by the host application, one or more of a size or a position of the graphical element within the host GUI; wherein said controlling the visual appearance of the graphical element includes removing the graphical element from display as part of the host GUI; wherein said controlling the visual appearance of the graphical element includes removing the graphical element from display as part of the host GUI, and reinserting the graphical element for display as part of the host GUI, said removing and reinserting being performed without affecting a run state of the component application; wherein said controlling the visual appearance of the graphical element does not include controlling content that is displayed as part of the graphical element.

A computer-implemented method for enabling an accessibility process to process content from a component graphical element of a component application, the method including: receiving an indication that an accessibility process is requesting access to a graphical element of a component application that is hosted in a graphical user interface (GUI) of a host application; communicating a pointer to the component application to the accessibility process; and causing processed content from the graphical element generated by the accessibility process to be output.

In addition to any of the above described methods, any one or combination of: further including receiving an indication that the accessibility process is requesting access to content displayed within the GUI of the host application outside of the graphical element of the component application; wherein the pointer includes an identifier for the component application; wherein the component application and the host application include two different respective types of applications, and where the method includes enabling the accessibility process to access host content presented in the GUI of the host application outside of the graphical element, and component content presented as part of the graphical element of the component application.

What is claimed is:

1. A system comprising:
at least one processor; and
one or more computer-readable storage media including instructions stored thereon that, responsive to execution by the at least one processor, cause the system to perform operations including:
receiving an indication that a host graphical user interface (GUI) of a host application is to host a component graphical element of a component application;
causing a shared visual handle to be retrieved to enable the creation of a shared visual in the host application and a shared visual target in the component application, the shared visual object representing the component graphical element, operable to receive visual output from the component application for display as part of the component graphical element, and enabling the host application to control one or more visual aspects of the component graphical element; and
causing the component graphical element to be displayed within the host GUI such that content from the component application is displayed as part of the component graphical element while the host application is protected from being accessible to the component application.

2. A system as recited in claim 1, wherein the indication that the host GUI is to host the component graphical element comprises one or more of a user request or a request from the host application.

3. A system as recited in claim 1, wherein the host application and the component application respectively represent instances of two different types of applications.

4. A system as recited in claim 1, wherein said causing the shared visual object to be communicated to the host application causes the shared visual object to be appended to a visual tree of the host application.

5. A system as recited in claim 1, wherein the operations further include:
receiving an indication that the component graphical element is to host a subcomponent graphical element of a subcomponent application;
causing a host/component relationship to be established between the component application and the subcomponent application; and
causing the subcomponent graphical element to be displayed as part of the component graphical element while the component graphical element is displayed as part of the host GUI.

6. A system as recited in claim 1, wherein the operations further include causing input to the component graphical element to be routed to the component application

7. A system as recited in claim 1, wherein the shared visual object enables content generated by the component application to be displayed as part of the graphical element, without enabling the host application to access the content.

8. A system as recited in claim 1, wherein the operations further include:
receiving an indication that the component application is to be disconnected from the host application;
causing the component application to be disconnected from the host application; and
causing the component application to be connected to one or more of the host application or a different host application such that the component graphical element is displayed within one or more of the host GUI for the host application or a different host GUI for the different host application.

9. A system as recited in claim 1, wherein the operations further include enabling an accessibility process to access component content presented within the component graphical element and host content presented in the host GUI outside of the component graphical element.

10. A computer-implemented method, comprising:
obtaining a shared visual object representing a graphical element generated by the component application;
causing the graphical element to be displayed within a host graphical user interface (GUI) of a host application; and
controlling, by the host application, a visual appearance of the graphical element within the host GUI by operating on the shared visual object and without accessing content populated to the graphical element by the component application.

11. A computer-implemented method as described in claim 10, wherein said receiving the shared visual object is based on a request from the host application for the graphical element.

12. A computer-implemented method as described in claim 10, wherein said causing the graphical element to be displayed with the GUI of the host application includes appending the shared visual object to a visual tree of the host application.

13. A computer-implemented method as described in claim 10, wherein said controlling the visual appearance of the graphical element comprises changing, by the host application, one or more of a size or a position of the graphical element within the host GUI.

14. A computer-implemented method as described in claim 10, wherein said controlling the visual appearance of the graphical element comprises removing the graphical element from display as part of the host GUI.

15. A computer-implemented method as described in claim 10, wherein said controlling the visual appearance of the graphical element comprises removing the graphical element from display as part of the host GUI, and reinserting the graphical element for display as part of the host GUI, said removing and reinserting being performed without affecting a run state of the component application.

16. A computer-implemented method as described in claim 10, wherein said controlling the visual appearance of the graphical element does not include controlling content that is displayed as part of the graphical element.

17. A computer-implemented method, comprising:
receiving an indication that an accessibility process is requesting access to a graphical element of a component application that is hosted in a graphical user interface (GUI) of a host application;
communicating a pointer to the component application to the accessibility process; and
causing processed content from the graphical element generated by the accessibility process to be output.

18. A computer-implemented method as described in claim 17, further comprising receiving an indication that the accessibility process is requesting access to content displayed within the GUI of the host application outside of the graphical element of the component application.

19. A computer-implemented method as described in claim 17, wherein the pointer comprises an identifier for the component application.

20. A computer-implemented method as described in claim 17, wherein the component application and the host application comprise two different respective types of applications, and where the method comprises enabling the accessibility process to access host content presented in the GUI of the host application outside of the graphical element, and component content presented as part of the graphical element of the component application.
